(19) United States
(12) Patent Application Publication
(10) Pub. No.: US 2025/0350548 A1
(43) Pub. Date: Nov. 13, 2025

(54) ARTIFICIAL INTELLIGENCE (AI)/MACHINE LEARNING (ML)-BASED PHYSICAL LAYER PARAMETER RECOMMENDATION

(71) Applicant: Cisco Technology, Inc., San Jose, CA (US)

(72) Inventors: Federico LOVISON, Fontanelle (IT); Ugo M. CAMPIGLIO, Morges (CH); Domenico FICARA, Essertines-Sur-Yverdon (CH); Juan Carlos ZUNIGA, Montreal (CA); Javier I. CONTRERAS ALBESA, Sant Cugat del Valles (ES); Jerome HENRY, Pittsboro, NC (US)

(21) Appl. No.: 19/205,672

(22) Filed: May 12, 2025

Related U.S. Application Data
(60) Provisional application No. 63/645,746, filed on May 10, 2024.
(60) Provisional application No. 63/670,355, filed on Jul. 12, 2024.

(51) Int. Cl. H04L 43/0882; H04L 5/00; H04L 41/16

(52) U.S. Cl. CPC H04L 43/0882; H04L 5/0007; H04L 41/16

(57) ABSTRACT

The present disclosure provides techniques for physical layer (PHY) parameter recommendation for improved link quality. An access point (AP) receives a recommendation request frame from a station (STA), the recommendation request frame comprising at least one of: one or more physical layer (PHY) parameters of the STA, a link margin of the STA, or one or more acceptable link degradation limits of the STA. The AP determines, based on the recommendation request frame, a recommended range for at least one of the PHY parameters, the recommended range being determined to maintain link performance within the acceptable link degradation limits. The AP transmits a recommendation response frame to the STA, the recommendation response frame comprising the recommended range, where the STA adjusts at least one PHY parameter based on the recommended range.

### CROSS-REFERENCE TO RELATED APPLICATIONS

This application claims benefit of co-pending U.S. provisional patent application Ser. No. 63/645,746 filed May 10, 2024 and co-pending U.S. provisional patent application Ser. No. 63/670,355 filed Jul. 12, 2024. The aforementioned related patent applications are herein incorporated by reference in their entirety.

### TECHNICAL FIELD

Embodiments presented in this disclosure generally relate to wireless network. More specifically, embodiments disclosed herein relate to artificial intelligence (AI)/machine learning (ML)-based techniques for physical layer (PHY) parameter recommendation.

### BACKGROUND

In wireless communication systems, the control of radio operational parameters, such as a station's transmission (TX) power, has a significant impact on the connection quality, power consumption, and even privacy. Transmission power that is too low may result in poor link quality, while excessive transmission power may cause regulatory violations, increased interference to neighboring devices, and unnecessary energy consumption. Existing methods in wireless local area networks (WLANs) involve access points (APs) enforcing transmission power constraints on associated stations (STAs), for example, through mechanisms such as transmit power control (TPC) defined in IEEE 802.11 standards.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless environment including an access point (AP) and a plurality of stations (STAs) at different distances, according to some embodiments of the present disclosure.

FIG. 2 depicts an example sequence of interactions between a STA and an AP for PHY parameter recommendation exchange, according to some embodiments of the present disclosure.

FIG. 3 depicts an example sequence of interactions between a STA and an AP for periodic, on-change, or autonomous asynchronous PHY parameter recommendation exchange, according to some embodiments of the present disclosure.

FIG. 4 depicts an example sequence of interactions between a STA and an AP for AP-initiated impact estimation and PHY parameter recommendation exchange, according to some embodiments of the present disclosure.

FIG. 5 depicts an example sequence of interactions between a STA and an AP for PHY parameter adjustment based on KPI reporting, according to some embodiments of the present disclosure.

FIG. 6A depicts an example process of training a machine learning (ML) model for PHY parameter recommendation generation based on historical connectivity data, according to some embodiments of the present disclosure.

FIG. 6B depicts an example process of generating PHY parameter recommendations using a trained ML model based on real-time AP detections and STA-provided information, according to some embodiments of the present disclosure.

FIG. 7 depicts an example method performed by an AP for PHY parameter recommendation generation, transmission, and ML model updating, according to some embodiments of the present disclosure.

FIG. 8 depicts an example method performed by a STA for locally determining and applying PHY parameter adjustments based on KPI information received from an AP, according to some embodiments of the present disclosure.

FIG. 9 is a flow diagram depicting an example method for PHY parameter recommendation generation at an AP, according to some embodiments of the present disclosure.

FIG. 10 is a flow diagram depicting an example method for PHY parameter adjustment at a STA, according to some embodiments of the present disclosure.

FIG. 11 depicts an example network device configured to perform various aspects of the present disclosure, according to some aspects of the present disclosure.

FIG. 12 depicts an example client device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by an access point (AP) and from a station (STA), a recommendation request frame comprising at least one of one or more physical layer (PHY) parameters of the STA, a link margin of the STA, or one or more acceptable link degradation limits of the STA, determining, by the AP, based on the recommendation request frame, a recommended range for at least one of the PHY parameters, the recommended range being determined to maintain link performance within the acceptable link degradation limits, and transmitting, by the AP, a recommendation response frame to the STA, the recommendation response frame comprising the recommended range, wherein the STA adjusts at least one PHY parameter based on the recommended range.

One embodiment presented in this disclosure provides a method, including transmitting, by a station (STA) and to an access point (AP), a link performance request frame comprising at least one of one or more physical layer (PHY) parameters of the STA, a link margin of the STA, or one or more acceptable link degradation limits of the STA, receiving, by the STA and from the AP, a link performance response frame comprising one or more link quality parameters associated with a communication link between the STA and the AP, determining, by the STA, based on the link performance response frame, an adjusted value for at least one of the PHY parameters, the adjusted value being determined to maintain link performance within the acceptable link degradation limits, and applying, by the STA, the adjusted value to modify the at least one PHY parameter.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### Example Embodiments

The adjustment of radio operational parameters, such as a STA's transmission power (TX power), has a significant impact on link quality as well as other aspects, such as the power consumption and user privacy. TX power that is too low may result in poor link quality, leading to reduced throughput and increased packet retransmission rate. Conversely, when the TX power is too high, the STA (also referred to as the client device) risks exceeding regulatory limits, causing excessive interference to neighboring devices and networks, and increasing unnecessary power consumption. Additionally, excessive TX power also increases the device's coverage footprint, which may compromise user privacy. Therefore, adjusting TX power and other relevant physical layer (PHY) parameters appropriately is important for maintaining optimized connectivity, improving energy efficiency, and maximizing (or at least improving) network capacity by reducing interference.

Existing methods in wireless local area networks (WLANs) generally involve APs enforcing TX power constraints on associated STAs, such as through transmission power control (TPC) mechanisms and/or radio resource management (RRM) algorithms, which focus on optimization from the infrastructure perspective. However, these methods are typically limited to static enforcement or broad configuration rules, and do not dynamically adapt based on the specific operation context of each STA or the real-time conditions of the wireless network. Specifically, there is a lack of mechanisms allowing STAs to obtain recommendations from the AP regarding optimal (or at least improved) TX power settings or other relevant PHY parameters, considering both the current network conditions and the application-specific or operational state of the STA.

The present disclosure provides methods, systems, and apparatuses that allow a STA to request a recommendation for adjusting radio operational parameters (including reducing TX power and other PHY parameters) in a manner that maintains the impact on link quality within an acceptable range specified by the STA according to its operational and application-specific requirements. One beneficial effect of the present disclosure is that it enables the STA to make informed decisions regarding the adjustment of PHY parameters by using additional contextual information provided by the AP, such as channel conditions, BSS load, and link stability. Although the AP offers recommendations, the STA retains the full control to decide how to apply the information and which operational parameters to adjust.

In addition, the interactive adjustments process also provides privacy benefits. By dynamically adapting its PHY parameters based on real-time recommendations and contextual information from the AP, the STA's PHY footprint evolves over time, even when the STA remains in a fixed physical location. In 802.11bi or other privacy-enhanced frameworks, where the media access control (MAC) address rotates at each epoch, the evolving PHY footprint makes it more difficult for unauthorized observers to correlate multiple MAC addresses as belonging to the same device. Furthermore, since the STA has discretion to accept, modify, or ignore the received recommendations, a lack of PHY changes cannot be automatically interpreted by the AP as malicious behavior. Therefore, the disclosed embodiments can effectively improve network security and preserve user privacy.

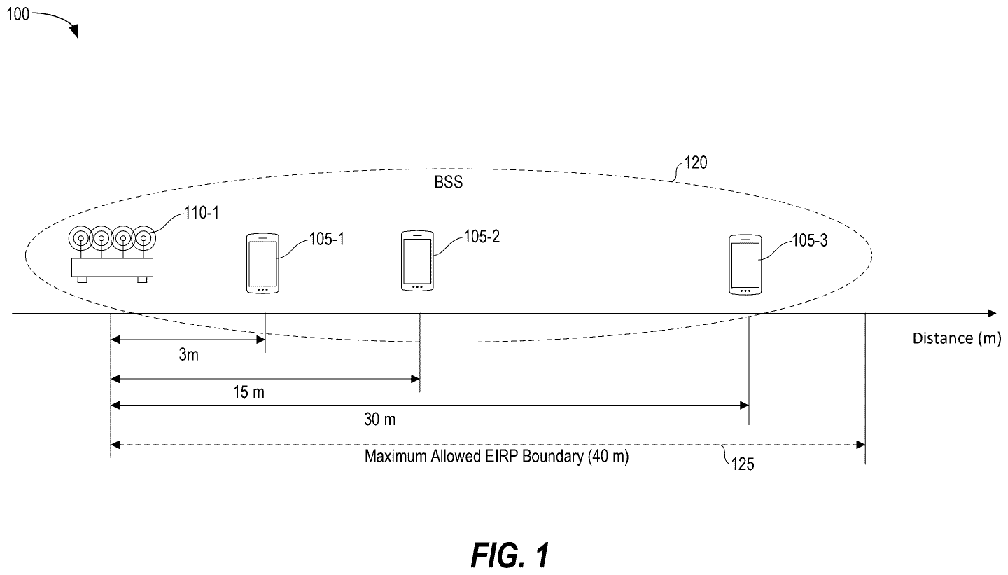

FIG. 1 depicts an example wireless environment 100 including an AP 110-1 and a plurality of STAs 105 at different distances, according to some embodiments of the present disclosure.

In the example wireless environment 100, AP 110-1 is connected to three STAs: STA 105-1, STA 105-2, and STA 105-3. The AP 110-1 and three STAs 105 form a basic service set (BSS) 120. As used herein, the AP 110-1 may represent any other network devices capable of providing wireless connectivity and managing wireless communications within the BSS, such as a wireless router or wireless local area network (LAN) controller (WLC). Each STA 105 may be a single-link or multi-link device capable of wireless communication with the AP 110 and, may include, for example, mobile phones, laptop computers, tablets, Internet-of-Things (IoT) devices, sensors, or other wireless equipment.

As depicted, the horizontal axis (e.g., x-axis) represents the distance from the AP 110, and the unit of measurement is meter. The respective distances between the AP 110-1 and the STAs 105 are different. As depicted, STA 105-1 is located approximately 3 meters from the AP 110-1, STA 105-2 is located approximately 15 meters from the AP 110-1, and STA 105-3 is located around 30 meters from the AP 110-1. A dashed line 125 shown approximately 40 meters from the AP 110-1 represents a maximum coverage boundary corresponding to the maximum allowed equivalent isotopically radiated power (EIRP) under regulatory constraints. Beyond this range, maintaining signal strength through increased transmission power would likely exceed the permissible power limits defined by wireless regulations.

Due to these varying distances and other environmental or operational factors (e.g., obstructions, interference levels, device type), each STA 105 experiences different link conditions and needs to adjust its transmission power and other PHY parameters to maintain reliable connectivity. For example, STA 105-1, being close to the AP 110-1, may achieve a high link margin with minimal transmit power. Therefore, STA 105-1 can conserve energy and limit interference to neighboring devices. STA 105-2 is located approximately 15 meters from AP 110-1, and may encounter moderate signal attenuation depending on intervening walls or nearby sources of interference. As a result, STA 105-2 may require moderate power levels to maintain stable performance. STA 105-3, located at approximately 30 meters, may face both increased path loss and greater variability due to mobility or channel fading effects. Thus, STA 105-3 may require more careful tuning of transmission power to maintain minimum link quality without exceeding regulatory EIRP limits. As used herein, link margin (e.g., dB) refers to the difference between the received signal strength at the receiver and the minimum receiver sensitivity required to decode a transmission with an acceptable error rate. A higher link margin generally corresponds to more reliable communication, while a low link margin increases the risk of packet loss or retransmission. In addition to distance, other factors may also contribute to the link performance, including but not limited to, device type, current traffic load, application-specific latency or throughput requirements, and background interferences. Therefore, optimal (or at least improved) PHY parameter configuration requires considering spatial positioning and/or real-time operating state for each STA 105 individually.

Conventional methods in WLANs typically address PHY parameter control from the infrastructure side. For example, AP 110-1 may enforce transmission power constraints on associated STAs 105 using mechanisms such as TPC or utilize RRM algorithms to optimize network performance across the BSS 120. However, these methods generally rely on static enforcement rules or broad, system-wide configurations. These methods lack the capability to dynamically adapt PHY parameter settings to the specific, real-time operating context of each STA.

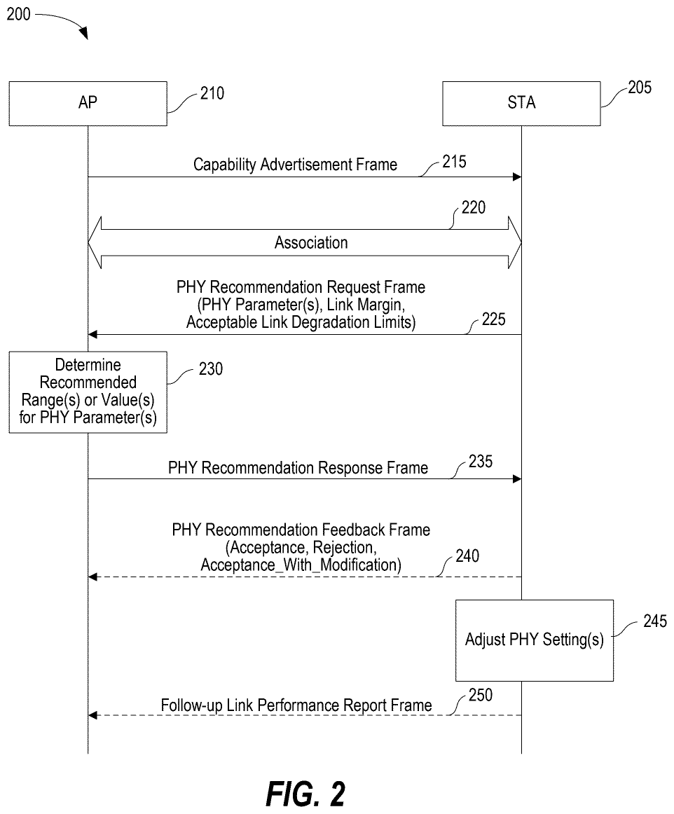

The present disclosure introduces a mechanism where the AP 110-1 can provide PHY parameter recommendations to individual STAs 105 based on current channel conditions and operational metrics. In one embodiment, each STA 105 sends a request specifying its current PHY configuration, link margin, and acceptable degradation limits (e.g., indicated by retry rate or throughput percentage). In response, the AP 110-1 evaluates the request and the included information, along with its own observations of real-time channel metrics, to determine a recommended range or value for one or more PHY parameters (e.g., transmit power, spatial streams, bandwidth). Through the communication, each STA 105 can make informed decisions adapted to its specific operating requirements. The interactive nature of this recommendation process further improves device privacy, as the STA's 105 PHY behavior becomes harder to replicate, even if an attacker reuses the same device identifier. Details about the PHY parameter recommendation mechanism are discussed below with reference to FIGS. 2-6.

FIG. 2 depicts an example sequence of interactions 200 between a STA 205 and an AP 210 for PHY parameter recommendation exchange, according to some embodiments of the present disclosure.

The AP 210 shown in FIG. 2 may correspond to the AP 110-1 as depicted in FIG. 1 and may include any type of network device configured to manage wireless connectivity within a BSS. The STA 205 in FIG. 2 may correspond to any of STA 105-1, 105-2, and 105-3 as depicted in FIG. 1, and may represent any wireless client device. Although FIG. 2 depicts a single STA and a single AP for clarity, similar interactions may occur in parallel or sequentially between the AP 210 and multiple associated STAs 205.

As depicted, before association, the AP 210 transmits a capability advertisement frame 215 to the STA 205. The advertisement may be transmitted using a beacon frame, a probe response, or any other suitable management or action frames as defined in established 802.11 standards. The advertisement frame 215 indicates the AP's support for extended spectrum management capabilities and, in some embodiments, includes TPC or Transmit Power Envelope (TPE) element, which defines allowable power limits for associated STAs. In some embodiments, the AP 210 may also advertise its ability to provide PHY key performance indicators (KPIs) and/or configuration recommendations to STAs (also referred to as the dot11SpectrumManagement capability). The advertisement frame 215 informs STA 205 that AP 210 supports recommendation-based PHY parameter optimization and can participate in an interactive communication process to assist STA 205 in adjusting its PHY settings in accordance with current network conditions and operational requirements.

Following the capability advertisement, the STA 205 initiates an association process with the AP 210 (as depicted by 220), including STA 205 transmitting an Association Request frame to AP 210, followed by AP 210 sending an Association Response frame back to STA 205. During the exchange, the STA 205 parses the information elements included in the advertisement, including any extended spectrum management capabilities and/or the presence of the dot11SpectrumManagement capabilities. If such a capability is detected, the STA 205 recognizes that the AP 210 supports the interactive PHY recommendation mechanism. Upon successful exchange of association frames, a wireless link is established between the STA 205 and the AP 210.

After a successful association with AP 210, as depicted, STA 205 may determine whether it intends to modify one or more of its PHY settings before data transmission. In such cases, the STA 205 transmits a PHY recommendation request 225 to the AP 210. In some embodiments, the frame 225 includes an indication of the STA's current transmission power and link margin. In addition to reporting current values, in some embodiments, the STA 205 further specifies one or more acceptable link degradation limits, which define the maximum allowable impact to connection quality resulting from potential PHY adjustments.

In some embodiments, the acceptable link degradation limits include a maximum allowable frame retry rate and/or a minimum acceptable throughput percentage relative to the current baseline throughput. In some embodiments, the limit is represented as absolute thresholds associated with PHY parameters. In some embodiments, the PHY recommendation request frame 225 identifies one or more specific PHY parameters that the STA 205 is willing to adjust. These PHY parameters may include transmission power, the number of spatial streams, channel bandwidth, or the allocation of resource units (RUS) in an orthogonal frequency-division multiple access (OFDMA) configuration. With the provided information in the request frame 225 (e.g., STA's current operational metrics and acceptable adjustment boundaries), AP 110 can generate a recommendation that aligns with the STA's application-specific requirements and operational constraints.

The PHY recommendation request may be transmitted using a management or action frame in accordance with established 802.11 standards. In some embodiments, the STA 205 includes the relevant operational metrics and adjustment boundaries in one or more vendor-specific information elements (IEs) or extends an existing element such as the TPC report element. In some embodiments, a new information element is defined to encapsulate the STA's current PHY configuration, link margin, acceptable degradation limits, and/or list of adjustable PHY parameters. The custom element may be carried within a management frame, an action frame, or another standardized signaling format that allows structured communication between the STA 205 and AP 210.

Upon receiving the PHY recommendation request frame 225 from the STA 205, the AP 210 processes the request 225 to determine an appropriate range or value for one or more PHY parameters (as depicted by 230). The AP 210 may consider both the information provided by the STA 205 and its own locally observed metrics. Specifically, in some embodiments, the AP 210 analyzes the STA's 205 current PHY capabilities and configuration constraints, as indicated within the request frame 225, including the link margin, acceptable degradation limits, and list of candidate parameters for adjustment. In addition, the AP 210 evaluates real-time link quality metrics such as received signal strength indicator (RSSI), signal-to-interference-plus-noise ratio (SINR), retry rate, and throughput for the requesting STA 205. The AP 210 may also consider connectivity statistics collected over a defined period of time (e.g., the past 5 minutes), which may include historical transmission success rates, packet error rates, or mobility indicators. Further, in some embodiments, the AP 210 may consider BSS-wide utilization metrics, such as channel occupancy and interference levels, as well as any applicable device-level configuration constraints and regulatory limits (e.g., maximum EIRP or restricted frequency bands) that may be included in the request 225 or known to the AP 210. Based on the aggregated information, the AP generates a recommended range or specific value for one or more PHY parameters, such as transmission power, the number of spatial streams, channel width, or OFDMA RU size and allocation. These adjusted parameters are expected to maintain the STA's link performance within the acceptable degradation limits defined in the request 225.

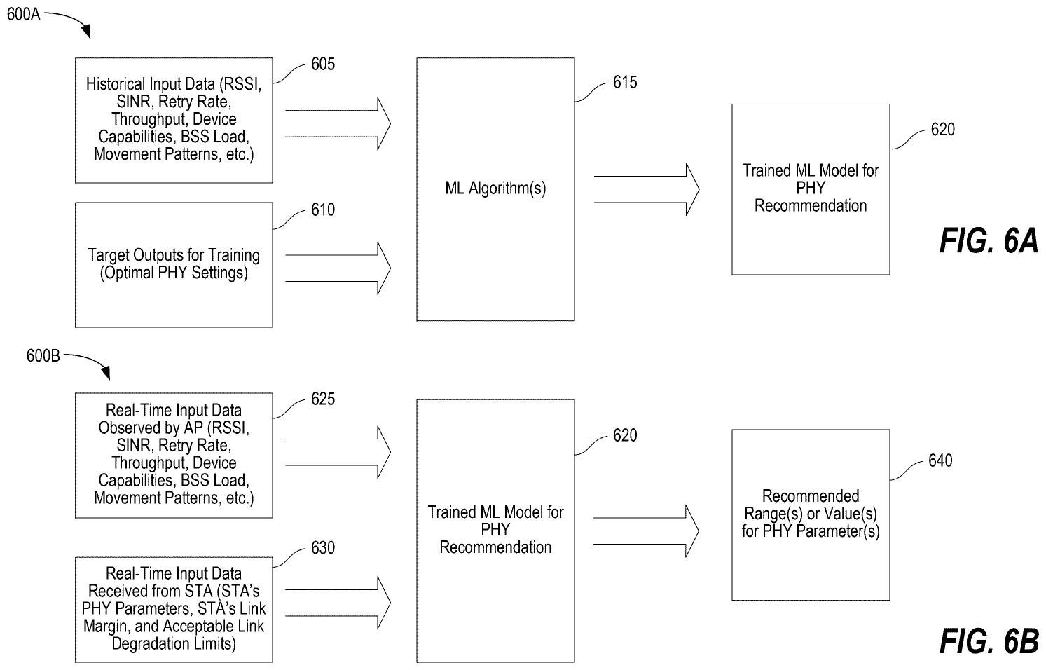

In some embodiments, the AP 210 generates the recommended PHY parameter ranges or values using artificial intelligence (AI)/machine learning (ML)-based models trained on historical connectivity statistics associated with the same STA 205 under varying conditions. The model may be trained on data such as past signal quality measurements, retry behavior, throughput patterns, mobility indicators, and BSS utilization metrics. During the inference phase, the AP 210 feeds the current operational metrics, including real-time link quality indicators, STA-reported configuration, and acceptable degradation limits, into the trained model to predict an optimal (or at least improved) PHY parameter adjustment that satisfies the STA's performance constraints. More details with regard to the training and inference processes for AI/ML-based implementation are discussed below with reference to FIG. 6.

In some embodiments, the recommendation is generated using a rule-based approach, where the AP 210 applies one or more predefined rule-based algorithms to the same input metrics to generate one or more recommended values or ranges.

The recommendation determined by the AP 210 may be structured into various forms, depending on implementation preferences and system design. In one embodiment, the recommended PHY parameter adjustment is expressed in the form of absolute values, specifying precise operational settings (e.g., 15 dBm for TX power, or 40 MHz channel width). In another embodiment, the recommendation is conveyed as a range (e.g., 10-20 dBm for TX power, or 20-40 MHz for channel width) or a relative delta with respect to the current settings (e.g., reduce TX power by 3 dB or increase channel width by one level). In another embodiment, the AP 210 transmits the recommendation using a predefined index-based format, where each index corresponds to a specific range of variation. For example, index A may indicate small variation (e.g., a couple of dB), index B may represent a moderate variation (e.g., 3-6 dB), and index C may correspond to a significant adjustment (e.g., 6-10 dB). The use of predefined indexes reduces overhead and simplifies interpretation by STA 205, particularly beneficial for environments having bandwidth constraints or highly dynamic operational contexts.

After determining the recommended PHY parameter ranges or values, the AP 210 transmits the recommendation to the STA 205 using a PHY recommendation response frame 235. In some embodiments, the information is encoded in a newly defined action frame, structured to carry recommendation content in a format that the STA 205 can easily interpret and apply. The action frame may include absolute values, relative adjustment values or ranges, or predefined variation indexes that map to predefined levels of adjustment.

In embodiments where privacy is a concern, such as when operating in compliance with IEEE 802.11bi or other enhanced privacy contexts, the recommendation may be transmitted in a protected action frame. The frame is encrypted using a key that has been previously established between the AP 210 and STA 205 during the association process or through a secure 4-way handshake. The use of encryption ensures that recommendation data is not visible to unauthorized observers and prevents leakage of operational information that could be used to infer the STA's behavior, traffic patterns, or physical location.

In some embodiments, the stability of the STA's connection and its historical mobility patterns may significantly influence the accuracy and longevity of the PHY parameter recommendation generated by the AP. For example, a STA that has been associated with the AP 210 for an extended period under relatively stable conditions may yield high-confidence recommendation results that remain valid for longer durations. In contrast, a STA that exhibits rapid movement, frequent signal fluctuations, or intermittent connectivity may result in low-confidence predictions, as the underlying link conditions are less predictable over time.

To support more informed decision-making by the STA 205, in some embodiments, the PHY recommendation response frame 235 optionally includes confidence and longevity metrics. The confidence metric indicates how reliable the recommendation is expected to be under current or near-future conditions, and the longevity metric represents an estimated duration over which the recommendation is expected to remain valid. These indicators enable the STA 205 to determine whether to strictly apply the recommended values, apply them with an additional safety margin, or defer application until updated information becomes available. In some embodiments, the longevity metric also informs the STA 205 of when to request a refreshed recommendation, particularly in dynamic wireless network environments.

In some embodiments, the AP 210 is unable to generate a sufficiently reliable recommendation. This may occur, for example, when the STA 205 has been associated for only a short period and insufficient historical data is available, or when high variability in link quality is observed (e.g., rapidly moving devices). In such configurations, the AP 210 transmits a PHY recommendation response frame 235 with no recommendation values. In some embodiments, the response frame 235 further includes a reason code indicating the cause of the omission, such as “insufficient data,” “unstable conditions,” or “high mobility detected.” The reason code allows the STA 205 to distinguish between a deliberate omission and a failure, and to respond accordingly.

After receiving the PHY recommendation response frame 235 from the AP 210, the STA 205 evaluates the recommended ranges or values in the context of its current operational state and application requirements. The STA 205 retains full control over how to apply the information. In one embodiment, the STA chooses to adhere strictly to the AP's guidance and implement the recommended PHY parameter changes exactly as suggested. In other embodiments, the STA 205 applies the recommendation with modification. For example, the STA 205 may slightly reduce the magnitude of a proposed TX power adjustment or select an intermediate bandwidth value in order to better align with device-specific constraints or application strategies. In some embodiments, the STA 205 determines that the recommendation does not meet its performance or policy objectives and chooses to disregard it entirely.

As depicted, the STA 205 may optionally transmit a PHY recommendation feedback frame 240 to the AP. The feedback frame 240 may include a status code indicating whether the recommendation was accepted, accepted with modification, or rejected. In embodiments where the recommendation is modified or rejected, the feedback frame may further include a reason code explaining the STA's decision, along with an optional report of the actual PHY parameters applied by the STA.

The STA 205 then applies the selected PHY parameter adjustments based on its internal evaluation of the recommendation received from the AP (as depicted by 245). The applied changes may include, for example, modification to transmit power, the number of spatial streams, channel width, modulation and coding schemes (MCS), or the configuration of OFDMA RUs. Depending on implementations, the PHY setting adjustments may occur before, after, or in parallel with the feedback transmission step. For example, the STA 205 may choose to implement the changes first and then send a feedback frame based on actual results, or the STA 205 may notify the AP 210 of its decision before applying the changes. In some embodiments, these operations may be pipelined or partially overlapped.

After implementing PHY parameter adjustments, as depicted, the STA 205 may optionally transmit a follow-up link performance report frame to the AP 210. The report may include the PHY parameters ultimately applied and one or more observed link performance indicators, such as post-adjustment throughput, retry rate, SNR, or packet error rate. The follow-up feedback allows the AP 210 to better understand the STA's 205 behavioral patterns and responsiveness to prior recommendations. In embodiments where the recommendation generation is supported by AI/ML-based models, the AP 210 may implement reinforcement learning techniques and/or iteratively refine the models using the feedback data. By correlating the STA's responses and outcomes with past recommendation strategies, the AP can iteratively improve the accuracy and effectiveness of its predictive models.

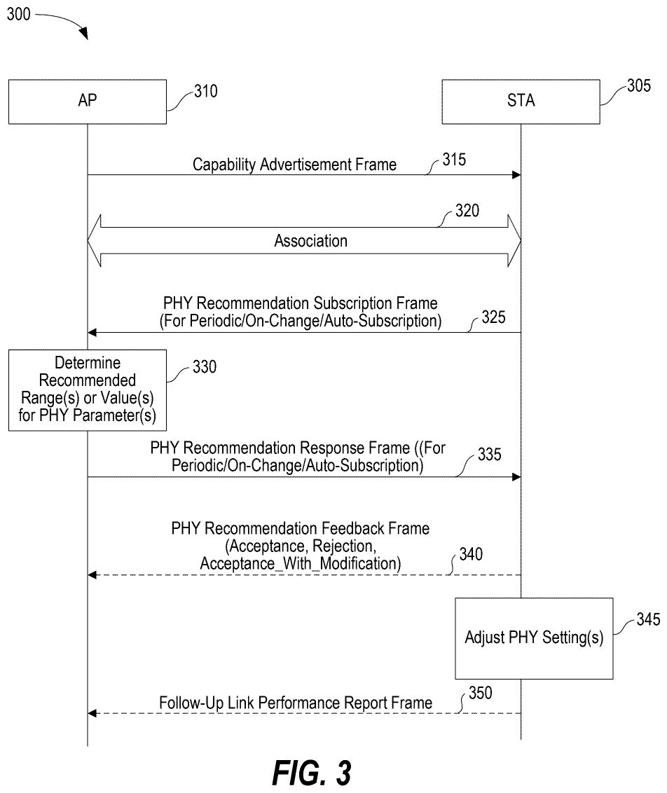

FIG. 3 depicts an example sequence of interactions 300 between a STA 305 and an AP 310 for periodic, on-change, or autonomous asynchronous PHY parameter recommendation exchange, according to some embodiments of the present disclosure.

The AP 310 shown in FIG. 3 may correspond to the AP 110-1 as depicted in FIG. 1 and may include any type of network device configured to manage wireless connectivity within a BSS. The STA 305 in FIG. 3 may correspond to any of STA 105-1, 105-2, and 105-3 as depicted in FIG. 1, and may represent any wireless client device. Although FIG. 3 depicts a single STA and a single AP for clarity, similar interactions may occur in parallel or sequentially between the AP 310 and multiple associated STAs 305.

Unlike the synchronous recommendation mechanism illustrated in FIG. 2, where the STA explicitly initiates a request in preparation for the PHY parameter adjustment, the mechanism in FIG. 3 supports asynchronous recommendation exchange. In asynchronous operations, the AP 310 may proactively transmit PHY recommendations based on subscription preferences previously established by the STA 305 without receiving a pre-adjustment request from the STA 305. This mechanism reduces signaling overhead and supports more responsive behavior in dynamic environments.

As shown in FIG. 3, the AP 310 and STA 305 begin with capability advertisement (e.g., by transmitting a capability advertisement frame 315 from AP 310 to STA 305) and association steps (as depicted by 320) similar to those described in FIG. 2. After successful association, the STA 305 transmits a PHY recommendation subscription frame 325 to the AP 310. The frame may indicate the STA's 305 preference to receive recommendations asynchronously and may include configuration parameters like desired update interval or one or more event conditions that would trigger an update.

In some embodiments, the subscription frame 325 indicates a request for periodic updates (e.g., every 10 seconds). In some embodiments, the subscription 325 indicates a request for on-change updates (also referred to in some embodiments as trigger-driven or trigger-based updates) and specifies one or more triggering conditions, such as signal degradation or retry rate thresholds. In some embodiments, the STA 305 indicates its capability to support asynchronous recommendations either within the subscription frame or via a capability advertisement transmitted prior to association (e.g., included in a probe request or beacon frame). In such configurations, the AP 310 autonomously initiates recommendation delivery when it detects meaningful or significant changes in network or link conditions, without requiring an explicit per-session subscription from the STA 305.

After the subscription is received or inferred, the AP 310 determines PHY parameter recommendations using the same decision mechanism described in FIG. 2, including AI/ML-based inference from real-time and historical metrics or rule-based approaches (as depicted by 330). Once a new recommendation is generated, the AP 310 transmits a PHY recommendation response frame 335 to the STA 305.

The timing of the transmission may depend on the subscription or capability indication provided by the STA 305. In some embodiments, the AP 310 transmits recommendations 335 at fixed periodic intervals specified in the STA's subscription request 325 (e.g., every 10 seconds or every 5 minutes). In some embodiments, the AP 310 transmits a recommendation only when a specified trigger condition is met, such as a drop in signal strength below a defined threshold, an increase in frame retry rate, or a change in MCS stability. These triggers may be provided by the STA 305 in its subscription request 325 or may be derived from observed metrics maintained by the AP 310. In some embodiments, the AP 310 monitors the link and autonomously initiates recommendation delivery when it detects meaningful or substantial changes in link quality, device behavior, or BSS conditions (e.g., an increase/decrease that exceeds a defined threshold). This occurs when the STA 305 does not issue a subscription request but previously indicated its support for asynchronous recommendation (e.g., via a capability advertisement).

The recommendation format may include absolute values (e.g., TX power=15 dBm), relative adjustments (e.g., reduce TX power by 3 dB), estimated ranges (e.g., 10-20 dBm for TX power), or predefined variation indexes (e.g., Index B for moderate adjustment).

Upon receiving the asynchronous recommendation, the STA 305 evaluates the information and determines how to proceed. The STA 305 retains full control over the application of the recommended PHY parameters. The STA 305 may optionally transmit a PHY recommendation feedback frame 340 to the AP 310, indicating whether the recommendation was accepted, accepted with modifications, or rejected. The feedback frame 340 may further include reason codes and/or adjusted parameters applied. The STA then implements the selected PHY adjustments (as depicted by 345). In some embodiments, the adjustment of PHY settings and the transmission of the feedback frame occurs simultaneously or in sequence, with either action occurring first depending on STA's internal logic.

The STA 305 may optionally transmit a follow-up link performance report frame 350 to the AP 310, including observed metrics after the PHY change. The AP 310 may use the feedback to update its internal models, whether based on rule sets or ML techniques. In embodiments involving AI/ML, the AP may apply reinforcement learning, using the STA's observed response and performance to refine future recommendations.

As in the synchronous flow depicted in FIG. 2, the PHY recommendation response frame in the asynchronous model may also include confidence and longevity metrics. These indicators allow the STA 305 to assess the expected reliability of the recommendation and determine how long the recommendation is likely to remain valid under current conditions. In some embodiments, if the AP 310 determines that it cannot generate a sufficiently reliable recommendation (e.g., due to insufficient historical data, high link variability, or transient interference), the AP 310 transmits an empty recommendation to the STA 305. The empty recommendation may further include a reason code indicating the cause (e.g., “insufficient data,” “unstable conditions,” or “high mobility detected”). The recommendation may be transmitted using a newly defined action frame. In embodiments where STA privacy is a concern (e.g., under IEEE 802.11bi or similar enhanced privacy configurations), the recommendation may be delivered in a protected action frame, encrypted using a key previously established between the AP 310 and the STA 305.

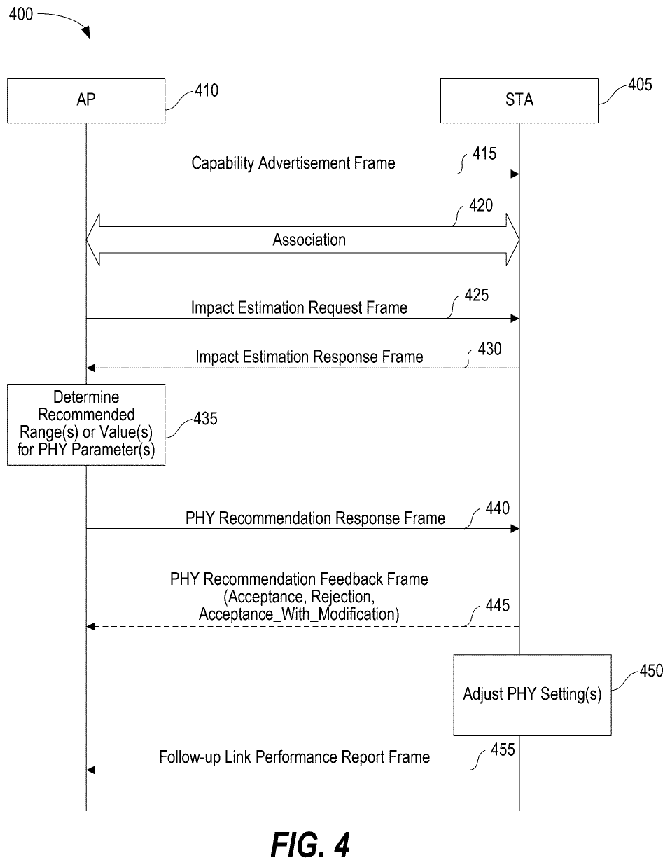

FIG. 4 depicts an example sequence of interactions 400 between a STA 405 and an AP 410 for AP-initiated impact estimation and PHY parameter recommendation exchange, according to some embodiments of the present disclosure.

The AP 410 shown in FIG. 4 may correspond to the AP 110-1 as depicted in FIG. 1 and may include any type of network device configured to manage wireless connectivity within a BSS. The STA 405 in FIG. 4 may correspond to any of STA 105-1, 105-2, and 105-3 as depicted in FIG. 1, and may represent any wireless client device. Although FIG. 4 depicts a single STA and a single AP for clarity, similar interactions may occur in parallel or sequentially between the AP 410 and multiple associated STAs 405.

Unlike the mechanism depicted in FIG. 2, where the recommendation process is initiated by a STA-issued request, the embodiment shown in FIG. 4 involves the AP initiating the query. This mechanism enables the AP 410 to proactively gather additional information from the STA 405 before generating a PHY recommendation. The additional information may include the STA-specific performance estimation data for accurate inference. The disclosed flow represents an extension to conventional TPC mechanisms and provides a more flexible and collaborative method for PHY tuning.

As depicted, the interaction 400 begins with the AP 410 broadcasting a capability advertisement 415, such as in a beacon or probe response frame, to nearby STAs. The advertisement may indicate the AP's 410 support for extended spectrum management features and include a dot11SpectrumManagement capability element that signals the AP's ability to provide PHY recommendations and receive impact estimations. Following this, the STA 405 associates with the AP 410 through standard association request/response procedures (as depicted by 420), during which the STA 405 parses the advertised capabilities.

After association, the AP 410 transmits a PHY impact estimation request frame 425 to the STA 405. The query 425 requests the STA 405 to estimate the potential performance impact that would result from applying one or more proposed PHY parameter changes. The parameters under consideration may include transmission power, channel width, MCS, spatial streams, or OFDMA RU size and allocations. The query/request 425 may also include contextual information such as the current link metrics or suggested adjustment ranges. In one embodiment, the query/request is carried in a newly defined action frame or element, which is designed to encode the list of candidate parameter changes and relevant metadata. In privacy-enhanced contexts, such as when operating under IEEE 802.11bi or similar protocols, the query/request 425 may be transmitted as a protected action frame, encrypted using a key previously established between the AP 410 and the STA 405 (e.g., during the association process or through a secure 4-way handshake).

Upon receiving the query/request frame 425, the STA 405 evaluates the potential effect of the specified adjustments and responds with a PHY impact estimation response frame 430. The response 430 may include predicted metrics such as estimated throughput, signal margin, retry rate, or quality-of-service (QOS) impact under each proposed configuration. In one embodiment, the response 430 is transmitted using a newly defined action frame or element that supports detailed structured reporting. When privacy is a concern, the response 430 may be encapsulated in a protected action frame, which is encrypted using an established session key. The use of protected action frames ensures that the STA's interaction with the AP 410 remains confidential and prevents leakage of intended adjustment configurations.

Using the impact estimation data received from the STA 405, along with observed real-time and historical link metrics (e.g., RSSI, SNR, packet error rates, BSS load), the AP 410 determines an appropriate recommendation range or value for one or more PHY parameters. The determination may be performed using a trained ML model or a rule-based logic engine. Once the recommendation is computed, the AP 410 transmits a PHY recommendation response frame 440 to the STA 405. The response 440 may include recommended adjustments for one or more PHY parameters, represented by absolute values, relative adjustments, estimated ranges, or predefined variation indexes. The frame may also optionally include confidence and longevity indicators, which inform the STA of the estimated reliability and expected duration of validity for the recommendation. In embodiments where the AP 310 determines that it cannot generate a sufficiently reliable recommendation (e.g., due to insufficient historical data, high link variability, or transient interference), the AP 410 may transmit an empty recommendation to the STA 405.

The STA 405 then evaluates the received recommendation and determines whether and how to apply the suggested adjustments. The STA 405 may choose to follow the recommendation exactly, modify it based on internal constraints or strategies, or disregard it entirely. The STA 405 retrains full control over the decision and may optionally transmit a PHY recommendation feedback frame 445 to the AP 410, indicating whether the recommendation was accepted, accepted with modification, or rejected, along with reason codes or the adjusted parameters. The STA 405 proceeds to apply the selected PHY adjustments (as depicted by 450). In some embodiments, the PHY parameter adjustments and the transmission of the feedback frame 445 may occur in parallel or in sequence, with either action occurring first based on the STA's internal logic or timing requirements.

Optionally, after applying the PHY changes, the STA 405 may transmit a follow-up link performance report frame 455 to the AP 410, including observed post-adjustment performance metrics and the applied PHY adjustments. The information may be used by the AP 410 to further improve future recommendations. In AI/ML-based systems, the feedback data may serve as part of a reinforcement learning loop that enables the AP 410 to adapt its models over time and generate increasingly accurate PHY recommendations adapted to each individual STA.

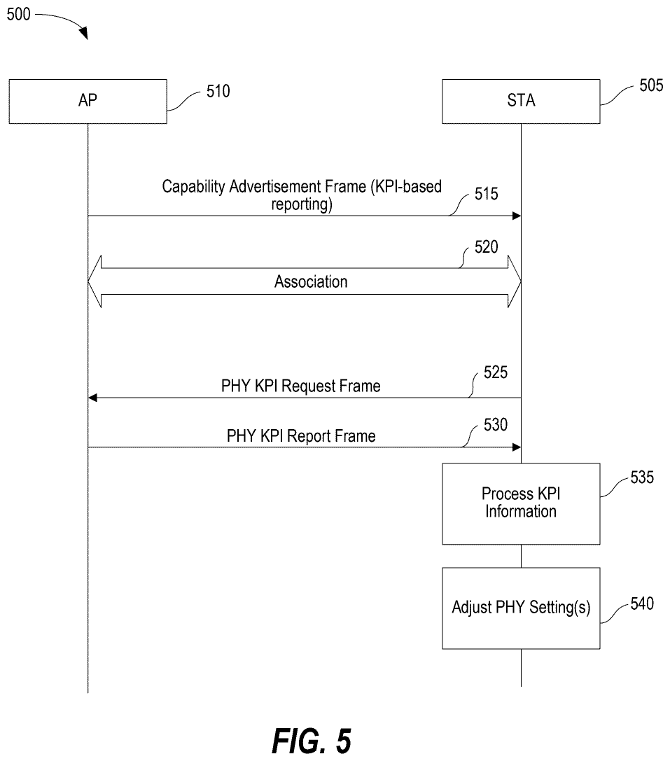

FIG. 5 depicts an example sequence of interactions 500 between a STA 505 and an AP 510 for PHY parameter adjustment based on KPI reporting, according to some embodiments of the present disclosure.

The AP 510 shown in FIG. 5 may correspond to the AP 110-1 as depicted in FIG. 1 and may include any type of network device configured to manage wireless connectivity within a BSS. The STA 505 in FIG. 5 may correspond to any of STA 105-1, 105-2, and 105-3 as depicted in FIG. 1, and may represent any wireless client device. Although FIG. 4 depicts a single STA and a single AP for clarity, similar interactions may occur in parallel or sequentially between the AP 410 and multiple associated STAs 505.

Unlike the flows depicted in FIGS. 2-4, where the AP is configured to generate and transmit PHY parameter recommendations, the mechanism illustrated in FIG. 5 enables the STA 505 to determine appropriate PHY adjustments based on key performance indicators (KPIs) provided by the AP 510. This embodiment provides an alternative model where the decision-making process is shifted to the client side, which may be applied where local adaptation is desired without relying on AP-side inference or recommendation logic. However, since recommendation inference may involve substantial computational processing, such as evaluating multiple PHY parameter combinations or running lightweight ML models, this embodiment may be desired in relatively simple environments (e.g., low mobility, limited network variability) or when the STA 505 has sufficient local processing capability, computing resources, and/or power budget to support such operations without degrading application performance or battery life.

The process begins with the AP 510 broadcasting a capability advertisement frame 515 (e.g., in a beacon or probe response) to nearby STAs. The advertisement 515 indicates the AP's support for extended spectrum management and KPI-based reporting. The STA 505 subsequently associates with the AP 510 through standard association request/response frames (as depicted by 520), during which the STA 505 recognizes the AP's support for PHY KPI reporting. Once associated, the STA 505 transmits a PHY KPI request frame 525 to AP 510. The request frame 525 indicates that the STA seeks performance-related metrics to guide local PHY parameter adjustments. In response, the AP 510 transmits a PHY KPI report frame 530 to the STA. The frame may include metrics such as RSSI, SINR, retry rate, MCS thresholds, and packet error rates. In some embodiments, the report frame 530 further includes link-layer performance statistics or any applicable device-level configuration constraints and regulatory limits (e.g., maximum EIRP or restricted frequency bands) to guide the STA's parameter adjustments.

The STA 505 processes the received KPI information and uses the information, along with the uplink (UL)/downlink (DL) SINR data, to determine how to adjust one or more PHY parameters before data transmission (as depicted by 535). The one or more PHY parameters may include transmission power, channel width, MCS, the number of spatial streams, or OFDMA RU configuration. The decision-making process may be performed using a locally hosted lightweight ML model trained on prior performance data or through rule-based algorithms incorporated within the STA's firmware or driver. Based on the outcome of the analysis, the STA 505 applies the selected PHY configuration adjustments locally (as depicted by 540). These adjustments may reduce unnecessary power consumption and improve link quality and the overall throughput.

FIG. 6A depicts an example process 600A of training a machine learning (ML) model for PHY parameter recommendation generation based on historical connectivity data, according to some embodiments of the present disclosure.

During the training phase, historical input data are collected from APs and associated STAs over time. The historical input data 605 may include connectivity metrics such as RSSI, SINR, retry rates, throughput levels, MCS transition patterns, channel width utilization, spatial stream usage, BSS load levels, device movement patterns, and application-specific traffic characteristics. The training data is aggregated along with environmental and operational metadata, such as time of day, interference levels, and STA device type, to maintain broad coverage across different operating scenarios.

Each training sample is associated with one or more target output values 610, such as the optimal (or at least improved) PHY parameter settings previously applied or known to have resulted in acceptable or optimal link quality under similar conditions. These output labels 610 may include absolute PHY values (e.g., transmit power=15 dBm), estimated ranges (e.g., 10-20 dBm for TX power), relative adjustments (e.g., decrease TX power by 3 dB), or predefined variation indexes (e.g., Index A for minor adjustment). The input-output pairs are used to train an ML model, using neural networks, decision trees, reinforcement learning, or other relevant algorithms or frameworks 615. The resulting trained ML model 620 is capable of predicting PHY parameter settings expected to maintain a STA's optimal (or at least improved) link quality under varying real-time conditions. The trained ML model 620 may be stored at an AP (e.g., AP 110-1 of FIG. 1), a wireless controller (WLC), or in a cloud-based optimization engine for use during the inference phase.

The metrics described herein for input data are provided as examples for conceptual clarity. In some embodiments, other relevant metrics related to link quality, traffic behavior, device movement, or interference may also be included depending on system configuration and learning objectives.

FIG. 6B depicts an example process 600B of generating PHY parameter recommendations using a trained ML model based on real-time AP detections and STA-provided information, according to some embodiments of the present disclosure.

During the inference phase, as depicted, real-time input data is collected, which may include both data 625 observed by the AP (e.g., 110-1 of FIG. 1) and data 630 received from the STA (e.g., 105 of FIG. 1) as part of a PHY recommendation request frame (e.g., 225 of FIG. 2). Observed data 625 may include link quality metrics (e.g., RSSI, SINR, retry rate, throughput), connectivity statistics collected over a defined time window (e.g., the last five minutes), BSS-wide indicators (e.g., airtime utilization, interference levels, and the number of active STAs), applicable device-level configuration or regulatory limits (e.g., maximum allowed TX power), and mobility patterns inferred from historical variation in signal characteristics. The STA-provided input data 630 may include its current PHY settings (e.g., TX power, the number of spatial streams, OFDMA configuration), link margin, and one or more acceptable degradation limits (e.g., retry rate thresholds or throughput percentages).

These combined inputs are processed by the trained ML model 620, which outputs one or more recommended PHY parameter ranges or values adapted to the STA's operational state and the current network conditions. The output of the inference process 640 may include absolute PHY values, relative adjustments, estimated ranges, or variation indexes, as discussed above. These results may be formatted and transmitted to the STA in a PHY recommendation response frame (e.g., 235 of FIG. 2, 335 of FIG. 3, or 440 of FIG. 4).

In embodiments where the STA subsequently transmits a feedback frame (e.g., 240 of FIG. 2, 340 of FIG. 3, 445 of FIG. 4) or follow-up report (e.g., 250 of FIG. 2, 350 of FIG. 3, 455 of FIG. 4), the AP may use this feedback to refine the trained ML model 620 to improve the accuracy of future predictions.

In some embodiments, the depicted ML training and inference operations are performed on the STA side, as shown in FIG. 5. In this configuration, the AP provides KPIs to the STA, and the STA runs its own locally hosted model to determine optimal (or at least improved) PHY parameter adjustments based on its internal policy or data-driven logic.

In some embodiments, the trained ML model is deployed on a wireless controller (WLC), edge computing device, or cloud-based service. In such configurations, the AP forwards observed and STA-provided metrics to the external component for processing. The resulting recommendations are then relayed back to the AP and transmitted to the STA. The offloading enables centralized or cloud-assisted intelligence without requiring high computation overhead at the AP itself.

In some embodiments, either the AP or the STA may utilize a rule-based recommendation engine instead of a data-driven model. In these embodiments, heuristic policies or rules may be applied to the same type of input metrics to determine PHY adjustments based on predefined thresholds, logical conditions, and/or adaptive scoring functions.

The stability of the STA's connection may significantly influence the accuracy and reliability of the recommendation generated by the model 620. For example, a STA that has been associated with the AP for an extended period with stable channel conditions provides more consistent and useful historical data for inference. This allows the ML model 620 to produce more accurate and longer valid predictions. In such configurations, the PHY recommendation response frame may also include confidence and longevity metrics, which inform the STA of the expected reliability of the recommendation and the estimated duration for which the guidance is likely to remain valid under current network conditions.

In some embodiments, the AP utilizes simulation-based techniques to supplement model training and assist in final recommendation generation. This may occur when insufficient historical data is available for a specific STA for model training. For example, when the STA has only recently associated or exhibits high mobility with unstable link metrics, the AP may not have accumulated enough observational data to support accurate ML inference. In such configurations, the AP may simulate a wireless connection with the STA for different combinations of ranges of one or more PHY parameters. Each simulated combination may be based on a predicted impact level associated with the corresponding PHY parameter (e.g., TX power, channel width, the number of spatial streams, or OFDMA allocation). The AP then determines, based on the simulation results, acceptable range values for each PHY parameter, where each acceptable range corresponds to a simulated connection strength that exceeds a defined minimum acceptable connection strength threshold (e.g., SINR). From this set of acceptable ranges, the AP may recommend a specific combination of range values to replace the STA's current operating configuration. This embodiment enables the AP to generate context-aware and accurate recommendations even in data-sparse environments.

The real-time input metrics described herein are provided as examples for conceptual clarity. In some embodiments, other relevant metrics related to link quality, traffic behavior, device movement, or interference may also be included depending on system configuration and learning objectives.

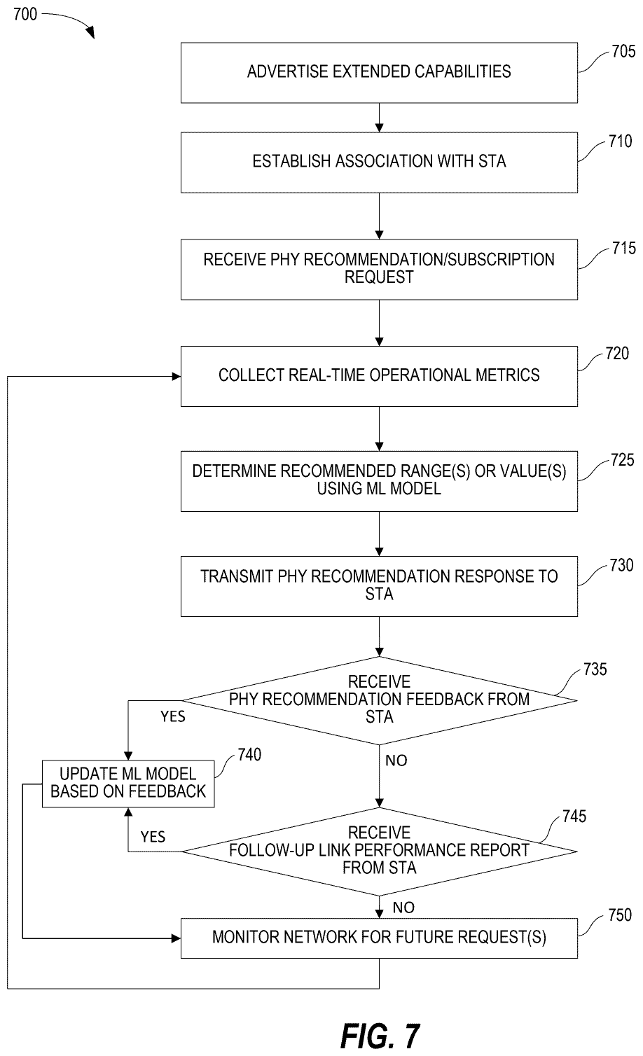

FIG. 7 depicts an example method 700 performed by an AP for PHY parameter recommendation generation, transmission, and ML model updating, according to some embodiments of the present disclosure. The example method 700 may be performed by any network device capable of managing PHY-level optimization for wireless communications, including but not limited to, a single-link or multi-link AP (e.g., AP 110-1 as depicted in FIG. 1, AP 210 as depicted in FIG. 2, AP 310 as depicted in FIG. 3, and AP 410 as depicted in FIG. 4), a WLC, a mesh coordinator, or a cloud-based optimization infrastructure.

At block 705, an AP (e.g., 110-1 of FIG. 1) broadcasts capability advertisements in beacon or probe response frames. The advertisement indicates the AP's support for extended spectrum management functions and, in some embodiments, includes the TPC or Transmit Power Envelope element, which defines allowable power limits for associated STAs. In some embodiments, the advertisement may further indicate the AP's ability to provide PHY recommendations to STAs (also referred to as the dot11SpectrumManagement capability).

At block 710, the AP establishes an association link with a STA (e.g., 105-1 of FIG. 1). More specifically, the STA first sends an association request frame to the AP, indicating its intent to connect to the BSS and optionally including its own capability information. Upon receiving the request, the AP evaluates whether to permit the association based on local policy and system resource availability. If approved, the AP responds with an association response frame that confirms the establishment of the association. During the exchange, the STA parses the advertised capability elements included in the AP's prior beacon or probe response frame. These may include the dot11SpectrumManagement capability or other indicators that the AP supports PHY parameter recommendation exchange.

At block 715, the AP receives a PHY recommendation request or a PHY subscription frame from the STA. When the STA operates in a synchronous mode, the STA transmits a PHY recommendation request (e.g., 225 of FIG. 2) to the AP. The transmission typically occurs when the STA intends to adjust its PHY settings, for example, in preparation for an upcoming transmission or in response to changing link conditions. In this configuration, the AP receives an explicit PHY recommendation request from the STA. The request may include the STA's current PHY settings (e.g., transmit power, channel width, spatial streams), the measured link margin, and one or more acceptable degradation limits (e.g., maximum retry rate, minimum throughput percentage). The information allows the AP to generate a targeted recommendation based on the STA's real-time needs and constraints.

When the STA operates in an asynchronous mode, the STA subscribes to receive PHY recommendations without initiating a separate request for each instance. In this configuration, the AP receives a PHY recommendation subscription (e.g., 325 of FIG. 3) frame from the STA. The subscription frame may indicate the STA's preference for periodic updates, event-triggered updates (also referred to in some embodiments as on-change updates), or simply advertise its capability to receive autonomous recommendations. In the periodic update mode, the STA may specify a desired interval (e.g., every 10 seconds), and the AP is configured to send recommendations to the STA at that frequency. In the event-triggered update mode, the STA may specify one or more triggering conditions (e.g., RSSI falling below a threshold, retry rate increasing, or changes in MCS stability). The AP monitors for these conditions and transmits a recommendation when one or more of these conditions is satisfied. In the autonomous update mode (also referred to as auto-subscription mode), the STA may either indicate its support for autonomous update in the subscription frame, or may omit the subscription frame entirely, instead signaling its capability to support asynchronous recommendation via earlier capability advertisement (e.g., in a probe request or beacon frame before association). Upon detecting this capability, the AP assumes responsibility for monitoring link conditions and autonomously initiates recommendation delivery when meaningful or significant changes (e.g., an increase/decrease that exceeds a defined threshold) are observed.

At block 720, the AP collects relevant operational metrics needed to generate an accurate and STA-specific recommendation. These metrics may include real-time link quality indicators, such as RSSI, SINR, retry rate, packet error rate, and throughput performance. Additionally, the AP may analyze connectivity statistics collected over a defined period (e.g., the past five minutes), which may include data such as packet delivery trends, stability of MCS, or roaming and handover events. The AP may also assess BSS-wide metrics, such as airtime utilization, interference from neighboring BSSs, and total STA load, to evaluate current channel conditions and spectrum occupancy.

In some embodiments, the AP may also incorporate device-specific configuration constraints and regulatory limits (e.g., maximum allowed transmit power) into consideration. The AP may further infer STA movement patterns by analyzing temporal variation in signal strength or association duration. The combination of these metrics provides the AP with a comprehensive view of both the STA's operational state and the surrounding wireless environment.

At block 725, the AP proceeds to generate one or more recommended values or adjustment ranges for PHY parameters. In this step, the AP considers both real-time metrics it has detected and the information explicitly provided by the STA in the request frame, including the STA's current PHY settings, reported link margin, and specified acceptable degradation limits (e.g., maximum retry rate or minimum throughput). The recommendation is computed to optimize link quality and maintain reliable wireless performance. The recommended ranges or values comply with applicable regulatory limits and respect the operating bounds defined by the STA. Depending on implementation, the computation may be performed using either trained ML models (as depicted in FIGS. 6A-6B) or rule-based heuristic algorithms.

In ML-based implementation, the AP inputs the combined metrics into a trained inference model (e.g., 620 of FIG. 6B), such as a neural network or reinforcement learning agent, which outputs predicted parameter values or adjustment ranges. The output may include absolute values (e.g., TX power=15 dBm), relative adjustments (e.g., decrease TX power by 3 dB), estimated ranges (e.g., 10-20 dBm for TX power), or predefined variation indexes indicating the magnitude of change (e.g., Index B for moderate adjustment). In rule-based systems, a predefined set of conditional logic may be used to generate similar recommendations based on threshold evaluations and decision rules.

The resulting recommendation may address one or more PHY parameters, including transmit power, channel width, the number of spatial streams, MCS, or OFDMA RU size and allocation.

At block 735, the AP transmits the recommended PHY parameter values or ranges to the STA in a PHY recommendation response frame. In a synchronous interaction, where the STA sends an explicit request in preparation for the PHY parameter adjustment (as depicted in FIG. 2), the recommendation is sent immediately in response to the STA's request. In asynchronous interactions (as depicted in FIG. 3), the recommendation may be sent periodically (if a fixed interval is specified), when one or more trigger conditions are detected, or autonomously when the AP determines a significant or meaningful change in network conditions justifies sending a new recommendation.

The recommendation frame may also include additional metadata such as confidence and longevity indicators. These fields help the STA to assess the expected reliability and validity duration of the recommendation under current conditions. In some embodiments, such as when STA privacy is a concern (e.g., in 802.11bi contexts), the response may be transmitted in a protected action frame encrypted using an established session key.

Following the transmission of the recommendation, at block 735, the AP determines whether it receives a PHY recommendation feedback (e.g., 240 of FIG. 2, 340 of FIG. 3, or 445 of FIG. 4) from the STA. The feedback frame allows the STA to inform the AP of its decision, whether the STA has fully accepted the recommendation, applied it with modification, or rejected it altogether. The feedback may include a status code indicating the outcome. In embodiments of rejection or modification, the feedback frame may also include a reason code and/or details about the actual PHY settings applied by the STA. If such feedback is received, the method 700 proceeds to block 740.

At block 740, the AP updates ML models based on the feedback. When the recommendation logic is ML-based, the AP may incorporate the feedback into the training or fine-tuning of the AP's model. The refinement process helps to improve future recommendation accuracy by learning from past outcomes and STA-specific behavior. Over time, this allows the AP to optimize recommendations based on how the STA typically responds to guidance under similar network conditions.

If no feedback is received, the method 700 proceeds to block 745, where the AP checks whether it receives a follow-up link performance report (e.g., 250 of FIG. 2, 350 of FIG. 3, or 455 of FIG. 4) from the STA. The report may contain post-adjustment metrics observed by the STA, such as throughput, retry rate, or RSSI, after applying the recommended or independently determined PHY settings. This information may still serve as valuable input for model refinement. If such a performance report is received, the method 700 cycles back to block 740, where the AP use the data in model updates. If neither feedback nor a performance report is received, the method 700 moves to block 750. At block 750, the AP returns to a passive monitoring state. In this state, the AP continues collecting real-time operational data and awaits future PHY recommendation requests from STAs (e.g., in synchronous mode) or trigger events (e.g., associated with asynchronous subscription modes). These trigger events may include, for example, the elapsing of a periodic update interval, detection of threshold-based link degradation, or any condition previously indicated by the STA in a subscription frame. Once a new request is received or a trigger condition is met, the method 700 restarts from block 720, where the AP generates and delivers a new PHY recommendation.

In some embodiments, instead of receiving a recommendation request or subscription from the STA, the AP may proactively initiate the interaction by transmitting a PHY impact estimation query (e.g., 425 of FIG. 4) to the STA. The frame may include one or more proposed changes to the STA's PHY configuration (e.g., suggested reductions in transmit power or adjustments to channel width) and request the STA to estimate the impact of such changes on link performance. The STA responds with an impact estimation response frame (e.g., 430 of FIG. 4), which may contain predicted metrics such as expected throughput, link margin, retry rate, or other QoS metrics under each proposed configuration. The AP-initiated query process enables the AP to gather additional context from the STA prior to generating a recommendation. In such configurations, the subsequent steps remain the same: the AP proceeds to collect real-time operational metrics (block 720), determine the PHY parameter recommendation (block 730), transmit the recommendation to the STA (block 735), and update the model if feedback or a performance report is received (block 740).

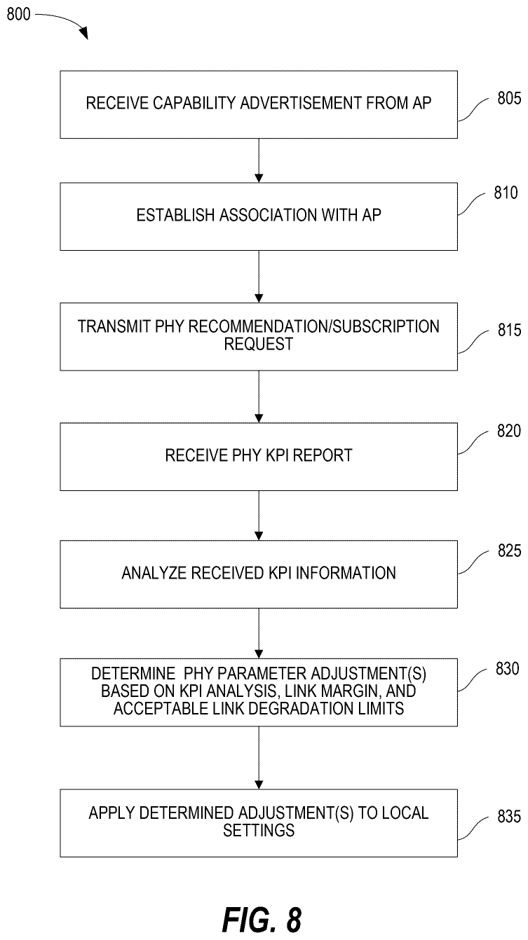

FIG. 8 depicts an example method 800 performed by a STA for locally determining and applying PHY parameter adjustments based on KPI information received from an AP, according to some embodiments of the present disclosure. The example method 800 may be performed by a client device, such as the STA 505 as depicted in FIG. 5. The disclosed method 800 enables local PHY decision-making at the STA side, without relying on the AP to compute a recommendation.

At block 805, a STA (e.g., 505 of FIG. 5) receives capability advertisements from an AP (e.g., 510 of FIG. 5) during beacon or probe response exchanges. These advertisements may indicate the AP's support for extended spectrum management and PHY-level KPI reporting. Based on this information, the STA determines that it can operate in a mode where it retrieves performance metrics from the AP to guide local PHY optimization.

At block 810, the STA initiates an association request to connect with the AP. Upon successful association, confirmed via the AP's association response, the STA completes its parsing of the advertised capabilities included in the AP's prior beacon or probe response frame.

At block 815, the STA transmits a PHY KPI request frame (e.g., 525 of FIG. 5) to the AP, indicating its intent to retrieve performance data relevant to its current PHY configuration and link status.

At block 820, the STA receives a PHY KPI report from the AP. The report may include a variety of metrics, such as RSSI, SINR, retry rates, supported MCS thresholds, packet error statistics, and the like. These KPIs may reflect historical averages, real-time conditions, or both. In some embodiments, the report frame further includes link-layer performance statistics or any applicable device-level configuration constraints and regulatory limits (e.g., maximum EIRP or restricted frequency bands) to guide the STA's parameter adjustments.

At block 825, the STA analyzes the received KPI data to assess its current link quality and identify potential areas for optimization.

At block 830, the STA determines one or more appropriate adjustments to its local PHY configuration. The STA may consider a combination of the KPI data received from the AP, the STA's own internal state (e.g., link margin) and policy, and performance constraints (e.g., acceptable link degradation limits). The STA may process these inputs using either a local rule-based logic engine or a ML model (e.g., 620 of FIG. 6B) that is trained on prior STA behavior under similar conditions. For example, if the STA observes strong RSSI and low retry rates but is using a high TX power level, the STA may reduce the TX power to conserve energy. If throughput is near the acceptable limit and SINR has degraded, the STA may increase the number of spatial streams or reduce the channel width to stabilize performance. The resulting output of the analysis may include a set of one or more target PHY parameter adjustments.

At block 835, the STA applies the determined adjustments to its local PHY configuration. These changes are configured to maintain acceptable link quality while improving power efficiency, reducing interference level, and/or supporting application-specific QoS requirements. The STA may continue monitoring post-adjustment performance and refine its adjustment strategy or model over time.

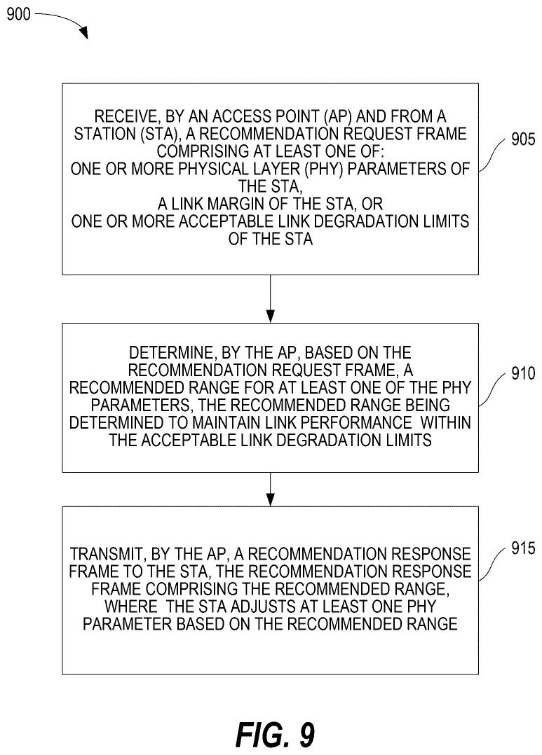

FIG. 9 is a flow diagram depicting an example method 900 for PHY parameter recommendation generation at an AP, according to some embodiments of the present disclosure.

At block 905, an AP (e.g., 110-1 of FIG. 1) receives a recommendation request frame (e.g., 225 of FIG. 2) from a STA. The recommendation request frame comprises at least one of one or more physical layer (PHY) parameters of the STA, a link margin of the STA, or one or more acceptable link degradation limits of the STA.

At block 910, the AP determines, based on the recommendation request frame, a recommended range for at least one of the PHY parameters, the recommended range being determined to maintain link performance within the acceptable link degradation limits.

At block 915, the AP transmits a recommendation response frame (e.g., 235 of FIG. 2) to the STA, the recommendation response frame comprising the recommended range, where the STA adjusts at least one PHY parameter based on the recommended range.

In some embodiments, to determine the recommended range, the AP may further analyze at least one of one or more device capacity parameters associated with the STA, one or more link quality parameters for a communication link between the AP and the STA over a defined time interval, one or more connection status parameters over a defined time interval, a basic service set (BSS) utilization metric, one or more device configuration constraints associated with the AP, or one or more regulatory configuration constraints.

In some embodiments, the AP may further transmit an advertisement frame (e.g., 215 of FIG. 2) comprising at least one of an indication of support for extended spectrum management, or an indication of support for providing PHY key performance indicator (KPI) reporting or PHY parameter recommendations.

In some embodiments, the one or more acceptable link degradation limits may comprise at least one of a maximum allowable frame retry rate, or a minimum acceptable throughput percentage relative to a baseline throughput value.

In some embodiments, the one or more acceptable link degradation limits may comprise one or more absolute values associated with PHY parameters, the PHY parameters comprising at least one of a transmit power level, a number of spatial streams, a channel bandwidth, or a resource unit (RU) allocation in an orthogonal frequency-division multiple access (OFDMA) configuration.

In some embodiments, the AP may further receive a recommendation feedback frame (e.g., 240 of FIG. 2) from the STA, indicating an acceptance of the recommended range.

In some embodiments, the AP may further receive a recommendation feedback frame (e.g., 240 of FIG. 2) from the STA, indicating a rejection of the recommended range, where the recommendation feedback frame comprises a reason code indicating a cause of the rejection.

In some embodiments, the AP may further receive a recommendation feedback frame (e.g., 240 of FIG. 2), indicating an acceptance with modification of the recommended range, where the recommendation feedback frame comprises a reason code indicating a cause of the modification and data specifying one or more adjusted PHY parameters.

In some embodiments, the AP may further receive a recommendation subscription request frame (e.g., 325 of FIG. 3) from the STA, indicating a request for periodic subscription of PHY parameter recommendations, the recommendation subscription request frame comprising a defined update interval. The AP may further transmit a plurality of second recommendation response frames (e.g., 335 of FIG. 3) to the STA based on the defined update interval.

In some embodiments, the AP may further receive a recommendation subscription request frame (e.g., 325 of FIG. 3) from the STA, indicating a request for on-change subscription of PHY parameter recommendations, the recommendation subscription request frame comprising one or more trigger conditions. The AP may further transmit a second recommendation response frame (e.g., 335 of FIG. 3) to the STA when one or more trigger conditions are satisfied.

In some embodiments, the AP may further receive a capability advertisement frame from the STA, the capability advertisement frame indicating that the STA supports an auto-subscription of PHY parameter recommendations. The AP may further transmit a second recommendation response frame to the STA without receiving a recommendation subscription request.

In some embodiments, the AP may transmit an impact estimation request frame (e.g., 425 of FIG. 4) to the STA, comprising one or more candidate PHY parameter adjustments. The AP may further receive an impact estimation report frame (e.g., 430 of FIG. 4) from the STA, comprising one or more predicted impacts associated with the one or more candidate PHY parameter adjustments.

In some embodiments, determining the recommended range may be performed at least in part using a machine learning model (e.g., 620 of FIG. 6) trained based on historical connection metrics associated with the STA.

In some embodiments, determining the recommended range may be performed at least in part using one or more predefined rule-based algorithms configured to analyze the recommendation request frame.

In some embodiments, the recommended range may comprise at least one of an absolute value for a PHY parameter, a relative adjustment value with respect to a current operating value of the PHY parameter, or an index corresponding to a predefined variation level of the PHY parameter.

In some embodiments, the recommendation response frame may be transmitted as a protected action frame encrypted using a security key established between the AP and the STA during an association process.

In some embodiments, in response to determining that the recommended range for at least one of the PHY parameters cannot be reliably generated based on available data, the AP may transmit a recommendation response frame to the STA, comprising an indication that no recommendation is provided and a reason code indicating a cause for a lack of recommendation.

In some embodiments, the recommendation response frame may further comprise at least one of a confidence indicator representing a predicted reliability level of the recommended range, or a longevity indicator representing an expected validity duration of the recommended range.

In some embodiments, determining the recommended range may be performed at least in part by a wireless controller or a cloud-based service coupled to the AP.

In some embodiments, to determine the recommended range for at least one or more PHY parameters, the AP may simulate a wireless connection between the AP and the STA for a plurality of different combinations of ranges of the one or more PHY parameters, where each combination of ranges is based on a predicted impact level associated with each of the one or more PHY parameters. The AP may determine, based on the simulation, a plurality of acceptable range values for each of the one or more PHY parameters, where each acceptable range corresponds to a simulated connection strength above a minimum acceptable connection strength threshold. The AP may recommend a combination of the plurality of acceptable range values to replace current operating ranges for the corresponding PHY parameters contributing to the wireless connection.

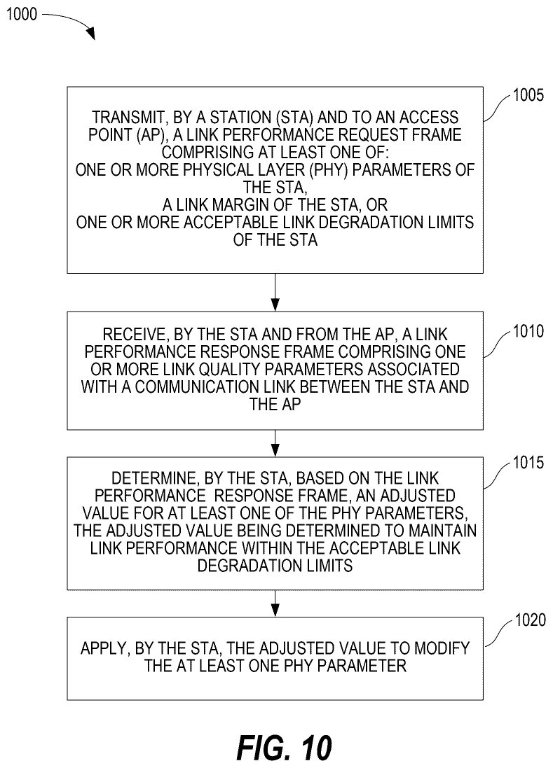

FIG. 10 is a flow diagram depicting an example method 1000 for PHY parameter adjustment at a STA, according to some embodiments of the present disclosure.

At block 1005, an STA (e.g., 105-1 of FIG. 1) transmits a link performance request frame (e.g., 525 of FIG. 5) to an AP (e.g., 110-1 of FIG. 1), comprising at least one of: one or more physical layer (PHY) parameters of the STA, a link margin of the STA, or one or more acceptable link degradation limits of the STA;

At block 1010, the STA receives a link performance response frame (e.g., 530 of FIG. 5) from the STA, comprising one or more link quality parameters associated with a communication link between the STA and the AP.

At block 1015, the STA determines, based on the link performance response frame, an adjusted value for at least one of the PHY parameters, the adjusted value being determined to maintain link performance within the acceptable link degradation limits.

At block 1020, the STA applies the adjusted value to modify the at least one PHY parameter.

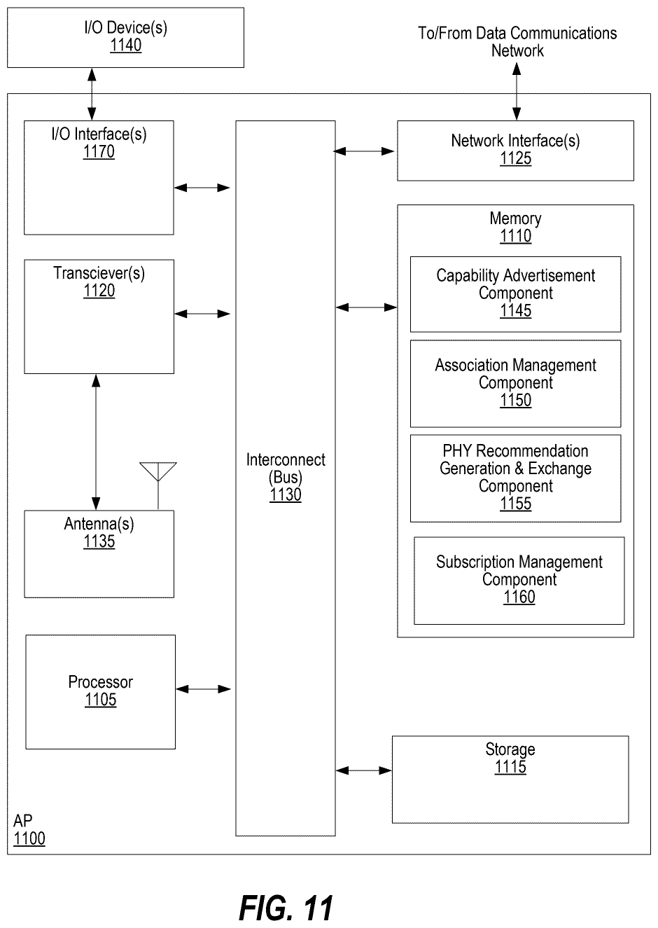

FIG. 11 depicts an example network device 1100 configured to perform various aspects of the present disclosure, according to some aspects of the present disclosure.

In some embodiments, the example network device 1100 may be an AP or any other type of network device (e.g., a router, switch, or network controller) that is capable of supporting the described functionality. In some embodiments, the example network device 1100 may correspond to AP 110-1 as depicted in FIG. 1, AP 210 as depicted in FIG. 2, AP 310 as depicted in FIG. 3, and AP 410 as depicted in FIG. 4.

As illustrated, the example network device 1100 includes a processor 1105, memory 1110, storage 1115, one or more transceivers 1120, one or more I/O interfaces 1180, and one or more network interfaces 1125. In some embodiments, I/O devices 1140 are connected via the I/O interface(s) 1180. Further, via the network interface 1125, the network device 1100 can be communicatively coupled with one or more other devices and components (e.g., via a network, which may include the Internet, local network(s), and the like). Each of the components is communicatively coupled by one or more buses 1130. In some embodiments, one or more antennas 1135 may be coupled to the transceivers 1120 for transmitting and receiving wireless signals.

The processor 1105 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1105 processes information received through the transceiver 1120, I/O interfaces 1180, and the network interfaces 1125. The processor 1105 retrieves and executes programming instructions stored in memory 1110, as well as stores and retrieves application data residing in storage 1115.

The storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1115 may store a variety of data for the efficient functioning of the system.

The memory 1110 may include random access memory (RAM) and read-only memory (ROM). The memory 1110 may store processor-executable software code containing instructions that, when executed by the processor 1105, enable the network device 1100 to perform various functions described herein for wireless communication. In the illustrated example, the memory 1110 includes four software components: the capability advertisement component 1145, the association management component 1150, the PHY recommendation generation & exchange component 1155, and the subscription management component 1160.

In one embodiment, the capability advertisement component 1145 is configured to generate and broadcast capability advertisement to nearby client devices. The component 1145 incorporates capability information into beacon, probe response, or other management frames. The capability information includes a support for extended spectrum management and a support for adaptive PHY recommendation or PHY-level KPI reporting.

In one embodiment, the association management component 1150 is configured to handle the exchange of association request and association response frames during the connection setup phase.

In one embodiment, the PHY recommendation generation & exchange component 1155 is configured to perform the functions of constructing and delivering PHY recommendations. The component 1155 handles incoming recommendation requests, collects real-time and historical metrics, computes recommended adjustments using ML or rule-based logic, and transmits PHY recommendation responses back to the requesting STA. In some embodiments, the component 1155 also supports protected action frame transmission for enhanced privacy deployments. In some embodiments, instead of passively handling requests from the STA, the component 1155 initiates AP-driven estimation queries to STAs. The component 1155 then processes STA's responses, which include predicted performance metrics under proposed PHY adjustments, and integrates that data into the recommendation pipeline.

In one embodiment, the subscription management component 1160 is configured to manage STA subscription for asynchronous PHY recommendations. The component 1160 tracks periodic and on-change subscriptions, stores associated parameters (e.g., update interval, trigger conditions), and coordinates with internal scheduling or event-monitoring logic to initiate recommendations at the appropriate time.

Although depicted as a discrete component for conceptual clarity, in some embodiments, the operations of the depicted components (and others not illustrated) may be combined or distributed across any number of components. Further, although depicted as software residing in memory 1110, in some aspects, the operations of the depicted components (and others not illustrated) may be implemented using hardware, software, or a combination of hardware and software.

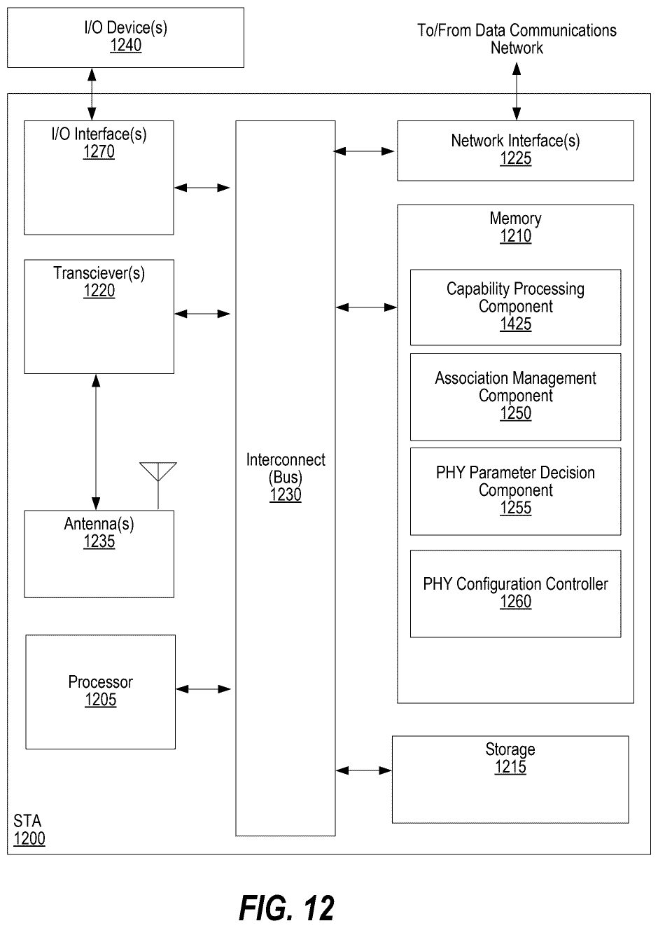

FIG. 12 depicts an example client device 1200 configured to perform various aspects of the present disclosure, according to some aspects of the present disclosure. In some embodiments, the example client device 1200 may correspond to STA 505 as depicted in FIG. 5.

As illustrated, the client device 1200 includes a processor 1205, memory 1210, storage 1215, one or more transceivers 1220, one or more I/O interfaces 1280, and one or more network interfaces 1225. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes four software components: the capability processing component 1245, the association management component 1250, the PHY parameter decision component 1255, and the PHY configuration controller 1260.

In one embodiment, the capability processing component 1245 is configured to process AP capability advertisements (e.g., via beacon or probe response frames) and determines whether the AP supports KPI reporting features.

In one embodiment, the association management component 1250 is configured to manage the STA's association process, including transmitting an association request, receiving an association response, and handling session-level context and capability negotiation.

In one embodiment, the PHY parameter decision component 1255 is configured to manage the KPI-based optimization process. The component 1255 transmits a link performance request to the AP, processes and analyzes the received KPI report data, and determines one or more PHY adjustments using either rule-based logic or a lightweight ML model.

In one embodiment, the PHY configuration controller 1260 is configured to apply the determined adjustments to the STA's wireless interface and reconfigure parameters such as transmit power, channel width, and stream count.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, by an access point (AP) and from a station (STA), a recommendation request frame comprising at least one of:
one or more physical layer (PHY) parameters of the STA,
a link margin of the STA, or
one or more acceptable link degradation limits of the STA;
determining, by the AP, based on the recommendation request frame, a recommended range for at least one of the PHY parameters, the recommended range being determined to maintain link performance within the acceptable link degradation limits; and
transmitting, by the AP, a recommendation response frame to the STA, the recommendation response frame comprising the recommended range, wherein the STA adjusts at least one PHY parameter based on the recommended range.

2. The method of claim 1, wherein determining the recommended range comprises analyzing, by the AP, further at least one of:
one or more device capacity parameters associated with the STA,
one or more link quality parameters for a communication link between the AP and the STA over a defined time interval,
one or more connection status parameters over a defined time interval,
a basic service set (BSS) utilization metric,
one or more device configuration constraints associated with the AP, or
one or more regulatory configuration constraints.

3. The method of claim 1, further comprising:
transmitting, by the AP, an advertisement frame comprising at least one of:
an indication of support for extended spectrum management, or
an indication of support for providing PHY key performance indicator (KPI) reporting or PHY parameter recommendations.

4. The method of claim 1, wherein the one or more acceptable link degradation limits comprise at least one of:
a maximum allowable frame retry rate, or
a minimum acceptable throughput percentage relative to a baseline throughput value.

5. The method of claim 1, wherein the one or more acceptable link degradation limits comprise one or more absolute values associated with PHY parameters, the PHY parameters comprising at least one of a transmit power level, a number of spatial streams, a channel bandwidth, or a resource unit (RU) allocation in an orthogonal frequency-division multiple access (OFDMA) configuration.

6. The method of claim 1, further comprising:
receiving, by the AP and from the STA, a recommendation feedback frame indicating an acceptance of the recommended range.

7. The method of claim 1, further comprising:
receiving, by the AP and from the STA, a recommendation feedback frame indicating a rejection of the recommended range, wherein the recommendation feedback frame comprises a reason code indicating a cause of the rejection.

8. The method of claim 1, further comprising:
receiving, by the AP and from the STA, a recommendation feedback frame indicating an acceptance with modification of the recommended range, wherein the recommendation feedback frame comprises a reason code indicating a cause of the modification and data specifying one or more adjusted PHY parameters.

9. The method of claim 1, further comprising:
receiving, by the AP and from the STA, a recommendation subscription request frame that indicates a request for periodic subscription of PHY parameter recommendations, the recommendation subscription request frame comprising a defined update interval; and
transmitting, by the AP, a plurality of second recommendation response frames to the STA based on the defined update interval.

10. The method of claim 1, further comprising:
receiving, by the AP and from the STA, a recommendation subscription request frame that indicates a request for on-change subscription of PHY parameter recommendations, the recommendation subscription request frame comprising one or more trigger conditions; and
transmitting, by the AP, a second recommendation response frame to the STA when one or more trigger conditions are satisfied.

11. The method of claim 1, further comprising:
receiving, by the AP, a capability advertisement frame from the STA, the capability advertisement frame indicating that the STA supports an auto-subscription of PHY parameter recommendations; and
transmitting, by the AP, a second recommendation response frame to the STA without receiving a recommendation subscription request.

12. The method of claim 1, further comprising:
transmitting, by the AP and to the STA, an impact estimation request frame comprising one or more candidate PHY parameter adjustments; and
receiving, by the AP and from the STA, an impact estimation report frame comprising one or more predicted impacts associated with the one or more candidate PHY parameter adjustments.

13. The method of claim 1, wherein determining the recommended range is performed at least in part using a machine learning model trained based on historical connection metrics associated with the STA.

14. The method of claim 1, wherein determining the recommended range is performed at least in part using one or more predefined rule-based algorithms configured to analyze the recommendation request frame.

15. The method of claim 1, wherein the recommended range comprises at least one of:
an absolute value for a PHY parameter,
a relative adjustment value with respect to a current operating value of the PHY parameter, or
an index corresponding to a predefined variation level of the PHY parameter.

16. The method of claim 1, wherein the recommendation response frame is transmitted as a protected action frame encrypted using a security key established between the AP and the STA during an association process.

17. The method of claim 1, further comprising:
in response to determining that the recommended range for at least one of the PHY parameters cannot be reliably generated based on available data, transmitting, by the AP, a recommendation response frame comprising an indication that no recommendation is provided and a reason code indicating a cause for a lack of recommendation.

18. The method of claim 1, wherein the recommendation response frame further comprises at least one of:
a confidence indicator representing a predicted reliability level of the recommended range, or
a longevity indicator representing an expected validity duration of the recommended range.

19. The method of claim 1, wherein determining the recommended range is performed at least in part by a wireless controller or a cloud-based service coupled to the AP.

20. The method of claim 1, wherein determining the recommended range for at least one or more PHY parameters comprises:
simulating, by the AP, a wireless connection between the AP and the STA for a plurality of different combinations of ranges of the one or more PHY parameters, wherein each combination of ranges is based on a predicted impact level associated with each of the one or more PHY parameters;
determining, by the AP, based on the simulation, a plurality of acceptable range values for each of the one or more PHY parameters, wherein each acceptable range corresponds to a simulated connection strength above a minimum acceptable connection strength threshold; and
recommending a combination of the plurality of acceptable range values to replace current operating ranges for the corresponding PHY parameters contributing to the wireless connection.

21. A method, comprising:
transmitting, by a station (STA) and to an access point (AP), a link performance request frame comprising at least one of:
one or more physical layer (PHY) parameters of the STA,
a link margin of the STA, or
one or more acceptable link degradation limits of the STA;
receiving, by the STA and from the AP, a link performance response frame comprising one or more link quality parameters associated with a communication link between the STA and the AP;
determining, by the STA, based on the link performance response frame, an adjusted value for at least one of the PHY parameters, the adjusted value being determined to maintain link performance within the acceptable link degradation limits; and
applying, by the STA, the adjusted value to modify the at least one PHY parameter.

22. A system of an access point (AP), comprising:
one or more memories collectively containing one or more programs; and
one or more processors, wherein the one or more processors are configured to, individually or collectively, perform an operation comprising:
receiving, by the AP and from a station (STA), a recommendation request frame comprising at least one of:
one or more physical layer (PHY) parameters of the STA,
a link margin of the STA, or
one or more acceptable link degradation limits of the STA;
determining, by the AP, based on the recommendation request frame, a recommended range for at least one of the PHY parameters, the recommended range being determined to maintain link performance within the acceptable link degradation limits; and
transmitting, by the AP, a recommendation response frame to the STA, the recommendation response frame comprising the recommended range, wherein the STA adjusts at least one PHY parameter based on the recommended range.
